(19) United States
(12) Patent Application Publication
(10) Pub. No.: US 2013/0249811 A1
(43) Pub. Date: Sep. 26, 2013

(54) CONTROLLING A DEVICE WITH VISIBLE LIGHT

(71) Applicants: Xiang Cao, Beijing (CN); Dominik Schmidt, Lancaster (GB); David Geoffrey Molyneaux, Kirkland, WA (US)

(72) Inventors: Xiang Cao, Beijing (CN); Dominik Schmidt, Lancaster (GB); David Geoffrey Molyneaux, Kirkland, WA (US)

(73) Assignee: MICROSOFT CORPORATION, Redmond, WA (US)

(21) Appl. No.: 13/428,880

(22) Filed: Mar. 23, 2012

(51) Int. Cl. H04Q 5/22; G06F 3/041

(52) U.S. Cl. 345/173; 340/10.1

(57) ABSTRACT

A user may control a user device utilizing visible light transmitted from a handheld control device. Upon a user actuation associated with the control device, the control device may transmit control information to one or more sensors associated with the user device. The control device may project a visual user interface on a display surface, whereby the visual user interface may represent commands and/or operations that may be performed by the user device. The user may also overlay the visual user interface, or components within the visual user interface, on the one or more sensors of the user device for transmitting a particular command to the user device. By virtue of the handheld device and the projected user interface, the user may both view operations that may be performed with respect to the user device and may also cause the user device to perform those operations.

### BACKGROUND

Today's environments are populated with a growing number of physical devices that come in different forms and that perform various functions. Rich interactions between a user and the devices may become challenging if the user is controlling the device from a distance and/or if the devices are too small to accommodate their own user interfaces. For instance, due to the limited size of certain remote control devices, those remote control devices may not have a surface large enough to incorporate a user interface. Further, even if a user interface was situated on such a remote control device, the limited size of the user interface may not allow the user to fully control the user device. Existing systems enable the user to control the devices with a remote control, which may be decoupled from the device and may include a user interface that is used to control the device. However, having such a remote control may cause the interaction between the user and/or the remote control and the device to no longer be direct. For instance, since the user interface may be situated on the remote control, the user may have to constantly divide and switch their attention between the controlling device (e.g., the remote control) and the controlled device (e.g., user device), thus possibly causing the user to become distracted.

Moreover, if the user desires to utilize a single remote control device to operate multiple user devices in a particular environment, the user may then have to explicitly select which user device is the intended target. This may become burdensome for the user if the list of candidate user devices is long and/or based on how the user devices are spatially located with respect to one another. For example, it may be difficult to transmit user commands to a particular user device if multiple user devices are in close proximity to the intended target device. Additionally, if the user utilizes multiple remote control devices to operate one or more user devices, the user may need to explicitly determine and select which remote control device to use, which may be inconvenient for the user. Further, in the context of a remote control device, the user may typically be limited by the size and (lack of) display capability of the remote control device, which may again constrain the richness of the user interaction and the visual expressiveness of the user interface.

### SUMMARY

Described herein are systems and processes for controlling a user device with visible light transmitted from a control device. More particularly, one or more user devices (e.g., a television, lamp, music player, etc.) may be operated and/or controlled via a control device (e.g., a remote control, a mobile telephone, etc.) that is operated by a user. Upon a user actuation associated with the control device, the control device may transmit control information in the form of visible light to one or more sensors associated with the user device. The control device may also project a visual user interface on a display surface (e.g., a wall, a table, etc.), whereby the visual user interface may represent commands associated with, and/or operations that may be performed by, the user device. In some embodiments, the user may overlay the visual user interface, or one or more components within the visual user interface, on the one or more sensors for the purpose of transmitting a particular command to the user device. In various embodiments, this command is transmitted using control information from the control device, which may also project the visual interface. As a result, by virtue of the handheld device and the projected user interface, the user may both view operations that may be performed with respect to the user device and also cause the user device to perform those operations.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including a user, a control device, a network, and a user device. In this system, the user may utilize a projected visual interface to control the user device.

FIG. 2 is a diagram showing an example system for presenting a visual interface and/or controlling a user device with visible light.

FIG. 3 is a diagram showing a system for utilizing a visual interface to control a user device.

FIG. 4 is a flow diagram showing an example process of controlling a user device based at least in part on a projected visual interface.

FIG. 5 is a flow diagram showing an example process of performing one or more operations based at least in part on a visual interface that is projected from a control device.

### DETAILED DESCRIPTION

Described herein are systems and/or processes for directly controlling user devices with visible light. More particularly, a handheld projector or a mobile device incorporating a projector may project an image that may be used to control and/or operate a user device. In some embodiments, the projected image may serve multiple purposes, such as simultaneously presenting a visual interface to the user and also transmitting embedded control information to sensors (e.g., sensor tags) that are integrated in, and/or otherwise associated with, the user devices. As a result, by enabling a user to both view a visual interface and control one or more user devices via a single remote device (e.g., a remote control, a mobile device, etc.), the user is provided with direct, visible, and/or rich interactions with user devices without having any central infrastructure.

As stated above, users may desire to control user devices (e.g., televisions, music players, etc.) at a distance with a remote control device. Moreover, as many user devices continue to shrink in physical size, these devices are less able to accommodate control interfaces on the devices themselves. As a result, the user interface in which the user can control the user device may be decoupled from the user device and externalized on a separate control device. This not only may allow users to control user devices at a distance, but may also provide access to a larger set of functions than is accommodated and/or desired through a user interface on the user device. However, as mentioned previously, incorporating the user interface in the remote control device may be burdensome for the user. For instance, user interaction with the user device may no longer be direct, it may be difficult to select and/or control a particular user device if multiple user devices are present, and/or the size of the user interface on the remote control device may limit the operations that the user may perform with the remote control device.

Accordingly, a handheld projector and/or a handheld control device that implements a handheld projector may be utilized to directly operate various user devices in an environment. In various embodiments, a user may utilize the hand-held device to project an image that may represent a visual user interface that may be used to operate the user device. Moreover, the user device may be controlled by directing the handheld device at the user device. That is, the handheld device may transmit visual light that is received by a sensor that is incorporated in the user device, which may cause the user device to perform operations in response to commands actuated by the user. In some embodiments, the user may point the handheld device at the user device that is to be controlled and cast a projected graphical user interface (GUI) over a sensor associated with the user device to perform a variety of interactions (e.g., GUI-type interactions, gesture-based interactions, etc.) to control the device. In other words, the user may use the image that is transmitted and/or projected from the handheld device in order to control the user device.

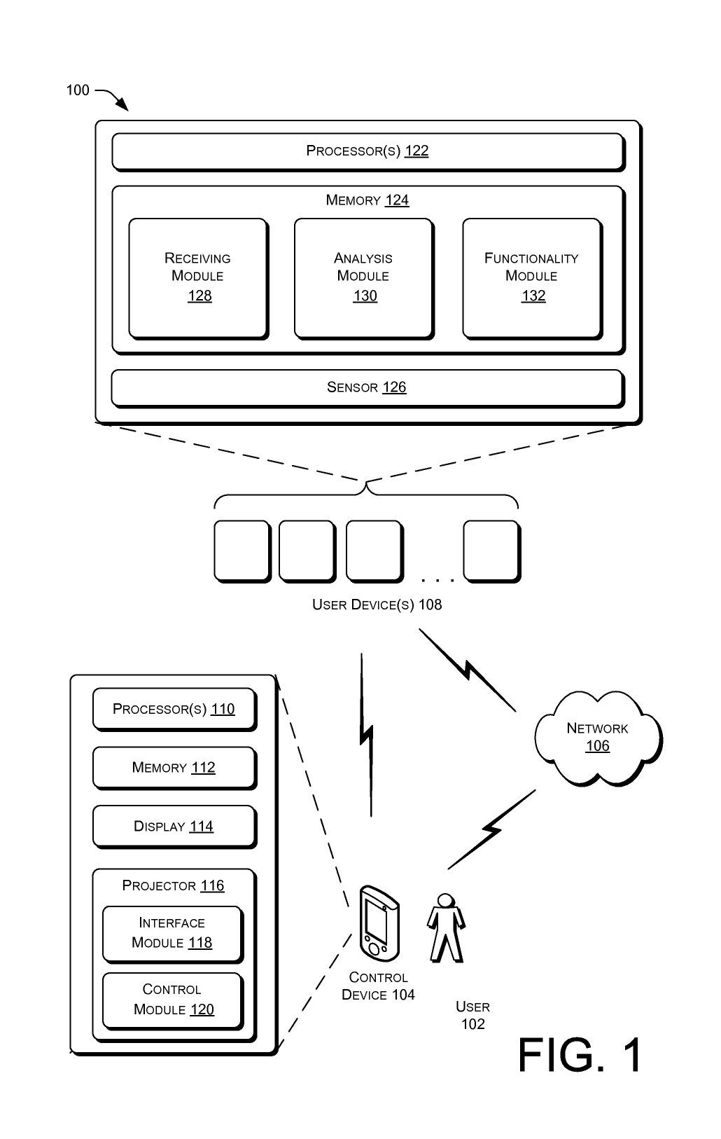

As a result, the user may not have to explicitly select the particular user device that is to be controlled and the user may instead provide their full attention to the user device, while also being able to view and/or utilize a visual user interface that is associated with controlling the user device. In other embodiments, the image projected by the handheld device (e.g., the remote control device) may serve a dual purpose, both for presenting a visual interface to the user, and for transmitting control information to a sensor (e.g., a sensor tag) associated with the user device by embedding sequential codes (e.g., binary codes, etc.) through visible light. Therefore, by projecting a visual user interface, the user is able to both view functionality associated with the user device that the user may control and actually cause that functionality to be performed. Various examples of controlling one or more user devices utilizing a projected visual interface, in accordance with the embodiments, are described below with reference to FIGS. 1-5.

FIG. 1 illustrates a system 100 for controlling one or more user devices utilizing control information and/or a visual interface projected from a remote control device. More particularly, the system 100 may include a user 102, a control device 104, a network 106, and one or more user device(s) 108. In various embodiments, the computing device 104 may include one or more processor(s) 110, memory 112, a display 114, and a projector 116, which may include an interface module 118 and a control module 120. Moreover, each user device 108 may include one or more processor(s) 122, memory 124, and a sensor 126. As shown, the memory 124 may include a receiving module 128, an analysis module 130, and a functionality module 132.

In various embodiments, the user 102 may utilize the control device 104 to control operations and/or functionality associated with the user device 108. More particularly, the user 102 may cause the control device 104 to project a visual interface that may be used to operate the user device 108. Furthermore, the control device 104 may transmit control information, such as visible light and/or the visual interface, to the user device in order to cause the user device 108 to perform various operations. In some embodiments, the control information may be received by the sensor 126 of the user device 108 and/or the visual interface may be projected over the sensor 126. Further, the user 102 may directly operate the user device 108 based at least in part on the image projected by the control device 104, which may be a visible interface and/or visible light that transmits embedded control information to the one or more sensors 126 associated with the user device 108. Various components of the control device 104 and the user device 108 will be described in additional detail as set forth below.

As stated above, and as shown in FIG. 1, control information (e.g., visible light, a visual interface, etc.) may be directly transmitted from the control device 104 to the user device 108. In alternate embodiments, the control information may be transmitted between the control device 104 and the user device 108 utilizing one or more networks 106. In various embodiments, the network 106 may be any type of network known in the art, such as the Internet and/or any type of wireless network, and may include multiple of the same or different networks. Wireless networks may transmit optical signals and/or radio waves to facilitate communications between various devices. Moreover, the control device 104 may be communicatively coupled to the network 106 in any manner, such as by a wired and/or wireless connection. Additionally, the network 106 may communicatively couple the control device 104 to the user device 108 such that the user 102 may operate the user device 108 by utilizing and/or manipulating the control device 104.

For the purposes of this discussion, the control device 104 may be any type of device that can be used to control one or more user devices 108. More particularly, the control device 104 may be any type of device that may project an image (e.g., a visual interface) and/or that may transmit control information (e.g., in the form of visible light or non-visible light (ultraviolet, etc.)) to the user device 108 for the purpose of operating the user device 108. For instance, the control device 104 may be a handheld projector, which may also be referred to as a pocket projector, a mobile projector, or a pico projector, among others. Alternatively, the control device 104 may be any type of wireless device and/or mobile device, such as a remote control, that is associated with a projector. For instance, a projector 116 or various projector components may be incorporated in the remote control such that the remote control is configured to project an image and/or a visual interface and/or is configured to transmit control information to the user device 108. In various embodiments, the control device 104 may project the image and/or visual interface onto any medium or viewing surface (e.g., a wall, a display screen, a device, etc.).

As shown in FIG. 1, the control device 104 may include one or more processor(s) 110, memory 112, the display 114, and the projector 116, which may include the interface module 118 and the control module 120. The techniques and mechanisms described herein may be implemented by multiple instances of the control device 104 and/or the user device 108, as well as by any other computing device, system, and/or environment. The control device 104, the network 106, and the user device 108 shown in FIG. 1 are only examples of a control device, a network, and a user device, respectively, and are not intended to suggest any limitation as to the scope of use or functionality of any control device, server, and/or user device utilized to perform the processes and/or procedures described herein. In various embodiments, the user 102 may utilize a single control device 104 (e.g., remote control) to project one or more visual interfaces and/or to control one or more user devices 108 (e.g., television, lights, music players, etc.) in a particular environment.

With respect to the control device 104, the processor(s) 110 may execute one or more modules and/or processes to cause the control device 104 to perform a variety of functions. In some embodiments, the processor(s) 110 may be a central processing unit (CPU), a graphics processing unit (GPU), both CPU and GPU, or other processing units or components known in the art. Additionally, each of the processor(s) 110 may possess its own local memory, which also may store program modules, program data, and/or one or more operating systems. The control device 104 may also possess some type of component, such as a communication interface, that may allow the control device 104 to communicate and/or interface with the network 106 and/or one or more devices, such as the user device 108.

Depending on the exact configuration and type of the control device 104, the memory 114 may be volatile (such as RAM), non-volatile (such as ROM, flash memory, miniature hard drive, memory card, or the like) or some combination thereof. The memory 114 may include an operating system, one or more program modules, and may include program data. In additional embodiments, the control device 104 may have additional features and/or functionality. For example, the control device 104 may also include additional data storage devices (removable and/or non-removable) such as, for example, magnetic disks, optical disks, or tape. Such additional storage may include removable storage and/or non-removable storage.

The control device 104 may also have input device(s) such as a keyboard, a mouse, a pen, a voice input device, a touch input device, one or more buttons, etc. Output device(s), such as the display 114, a light-emitting component, speakers, a printer, etc. may also be included. In some embodiments, the user 102 may utilize the foregoing features to project a visual interface on a display surface and/or to control the user device 108. For instance, the input device(s) of the control device 104 may be used to project a visual interface that may be utilized to control the user device 108. Additionally, the input device(s) of the control device 104 may be used to transmit control information that may be received by the sensor 126 of the user device 108, which may cause the user device 108 to perform certain functionality. For example, the control information may cause the user device 108 to power on or off, to adjust the volume, to adjust brightness, etc.

In some embodiments, provided that the control device 104 is a handheld projector or a device that is somehow associated with a projector, the control device 104 may include hardware and/or software that are able to project images onto any nearby viewing surface, such as a wall or the user device 108 itself. In various embodiments, the projector 116 may include an interface module 118 that may project an image and/or a visual interface onto any type of display surface. Further, the visual interface may be associated with one or more of the user devices 108, and may visually represent actions that the user 102 may take to control the user devices 108. For example, the visual interface may display buttons, animations, and/or any other components that display any other commands the user 102 may take with respect to the user device 108.

Moreover, the control module 120 of the control device 104 may be configured to transmit control information to the user device 108. In some embodiments, the control information may take the form of visible light and may be received by the sensor 126 of the user device 108. More particularly, the user 102 may project a visual interface that may cause the user device 108 to perform various actions and/or functions. For example, upon projecting a visual interface, the user 102 may select one or more options or commands displayed in the visual interface. As a result, the visual interface and/or other control information may be directed towards the sensor 126 of the user device 108 in order to cause the user device 108 to perform those options or commands.

In additional embodiments, the control device 104, and/or the projector 116 in particular, may include a battery, various electronics, one or more laser light sources, a combiner optic, and/or one or more scanning mirrors. In order to project an image and/or a visual interface, the electronics may convert the image that is to be projected into one or more electronic signals. Next, the electronic signals may drive laser light sources, which may have different colors and/or intensities, down one or more different paths. The combiner optic may then combine the different light paths into a single path that may demonstrate a palette of colors. Furthermore, the scanning mirrors may copy the image pixel-by-pixel and then may project the image. In various embodiments, the components described above may be set forth on a single integrated circuit (e.g., a chip) and the projector 116 may be configured to project a clear image and/or visual interface, regardless of the physical characteristics of the viewing surface in which the image is to be projected. In other embodiments, other types of projector technologies may be utilized, such as Digital Light Processing®, for example.

It is appreciated that the illustrated control device 104 is only one example of a suitable device and is not intended to suggest any limitation as to the scope of use or functionality of the various embodiments described. Other well-known computing devices, systems, environments and/or configurations that may be suitable for use with the embodiments include, but are not limited to, remote control devices and any mobile and/or wireless devices, such as personal computers, hand-held or laptop devices, multiprocessor systems, microprocessor-based systems, set top boxes, game consoles, programmable consumer electronics, network PCs, minicomputers, and/or distributed computing environments that include any of the above systems or devices. In addition, any or all of the above devices may be implemented at least in part by implementations using field programmable gate arrays (“FPGAs”) and application specific integrated circuits (“ASICs”), and/or the like.

In other embodiments, and as stated above, the user device 108 may be any type of device that is configured to perform some type of function and/or operation in response to a user command. More particularly, the user device 108 may receive control information (e.g., a visual interface, visible light, etc.) and perform a particular function based at least in part on the received control information. As mentioned previously, the user device 108 may include one or more processor(s) 122, memory 124, which may include the receiving module 128, the analysis module 130, and the functionality module 132, and the sensor 126. In various embodiments, the processor(s) 122 and the memory 124 may be similar to or different from the processor(s) 110 and the memory 112, respectively, of the control device 104.

In various embodiments, the user device 108 may be controlled by the control device 104, which may be a remote control or any other type of mobile and/or wireless device. Moreover, the user device 108 may be controlled based at least in part on control information, which may include a visual interface and/or visible light, that is projected by the control device 104 and received by the user device 108. In some embodiments, the receiving module 128 of the user device 108 may receive the control information that is transmitted and/or projected by the control device 104. More particularly, the control information may be received by the sensor 126 (e.g., one or more sensor tags) that is integrated within the user device 108. The receiving module 128 may function in conjunction with the sensor 126 in order to receive the control information. Moreover, the receiving module 128 may receive one or more commands from the control device 104 based at least in part on the visual interface, and/or components within the visual interface, being overlaid on the sensor 126. For instance, the user 102 may direct the visual interface over the sensor 126 in order to transmit commands to the user device 108.

Once the control information is received from the control device 104, the analysis module 130 may analyze the received control information to determine the commands that the control information represents. That is, provided that the user 102 transmitted one or more commands to the user device 108 via the control device 104, the analysis module 130 may determine the functions that have been requested by the user 102. For example, assume that the user device is a television, the user 102 may enter commands (e.g., power on/off, adjust volume, change channel, etc.) for the purpose of controlling the television. Upon some user actuation on the control device 104 that is associated with the user command (e.g., adjusting the volume), the control device 104 may transmit control information that is representative of the user command. The analysis module 130 may receive this control information via the sensor 126 and determine which user command has been requested by the user 102. That is, the analysis module 130 may determine that the user 102 has transmitted a command to adjust the volume of the television. In some embodiments, the command to adjust the volume may be received by the user 102 placing a component that is representative of adjusting the volume over the sensor 126.

Upon making this determination, the functionality module 132 may cause the user device 108 to perform the operation(s) and/or function(s) that were previously requested by the user 102. For instance, after the analysis module 130 has determined that the control information transmitted by the control device represents a command to adjust the volume of the user device 108, the functionality module 132 may then carry out the user command by adjusting the volume of the user device 108.

As stated above, the control information may be directed to and received by the sensor 126 associated with the user device 108. For the purposes of this discussion, each user device 108 may include a single sensor 126 or multiple sensors 126. In some embodiments, the sensor 126 may be integrated in the user device 108, attached or mounted to the user device 108, and/or otherwise associated with the user device 108. The control information may be received by transmitting visible light directly to the sensor 126 and/or projecting a visual interface and/or image over the sensor 126. In any event, the control information may be directly transmitted from the user 102 to the user device 108 via the control device 104.

With respect to the control device 104 and/or the user device 108, computer-readable media may include, at least, two types of computer-readable media, namely computer storage media and communication media. Computer storage media may include volatile and non-volatile, removable, and non-removable media implemented in any method or technology for storage of information, such as computer readable instructions, data structures, program modules, or other data. The memory 112 and 124, the removable storage and the non-removable storage are all examples of computer storage media. Computer storage media includes, but is not limited to, random-access memory (RAM), read-only memory (ROM), electrically erasable programmable read-only memory (EEPROM), flash memory or other memory technology, compact disc read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the control device 104 and/or the user device 108. Any such computer storage media may be part of the control device 104 and/or the user device 108. Moreover, the computer-readable media may include computer-executable instructions that, when executed by the processor(s) 110 and 122, perform various functions and/or operations described herein.

In contrast, communication media may embody computer-readable instructions, data structures, program modules, or other data in a modulated data signal, such as a carrier wave, or other transmission mechanism. As defined herein, computer storage media does not include communication media. In various embodiments, memory 112 and 124 may be examples of computer-readable media.

As a result, the user 102 may transmit control information, such as visible light and/or a visual interface, from the control device 104 directly to the user device 108 in order to control the user device 108. In various embodiments, the control information and/or the visual interface may be received by the sensor 126 associated with the user device 108. The visual interface may be projected by the control device 104, which may be a handheld projector or a device that is configured to act as a projector, and the visual interface may represent functions and/or operations that may be performed with respect to the user device 108. Accordingly, the control device 104 may enable the user 102 to directly control the user device 108, while also projecting a visible interface associated with the user device 108 and providing the user 102 with a rich user experience.

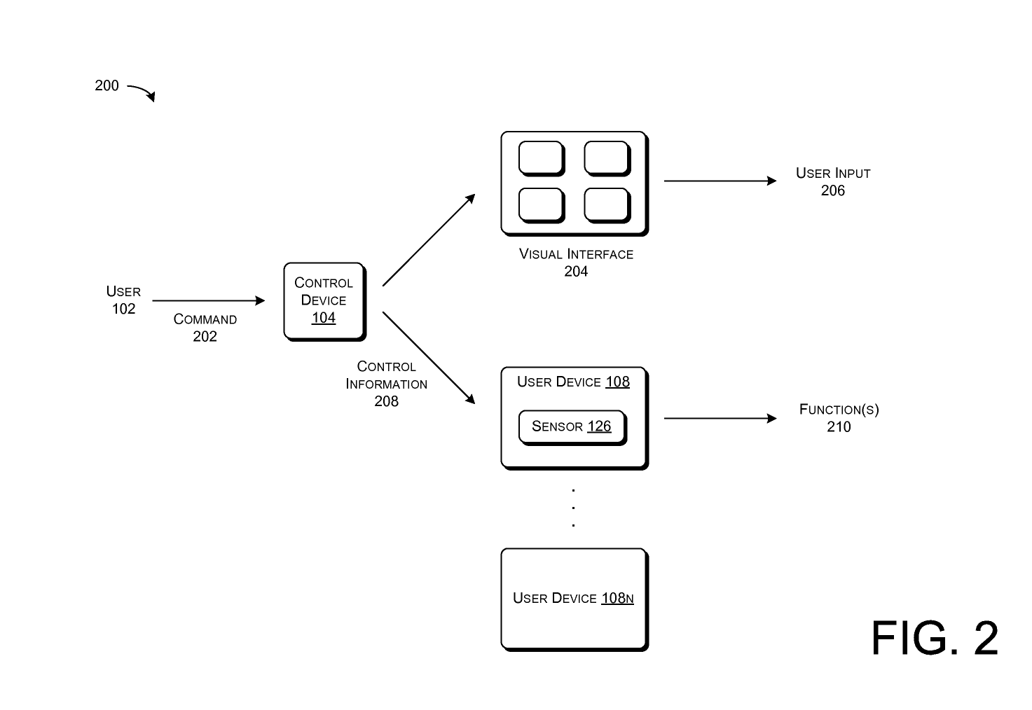

FIG. 2 illustrates a system 200 for controlling one or more user devices utilizing a control device, such as a remote control. More particularly, the system 200 may enable a user 102 to project and/or transmit control information, such as visible light and/or a visual interface from a control device 104 to a particular user device 108. In various embodiments, the control information may represent one or more user commands that may be received by a sensor 126 associated with the user device 108. As a result, the user 102 may both control the user device 108 and view a visual user interface that may be projected on any physical surface for the purpose of controlling functionality of the user device 108. In various embodiments, the control device 104 may be used to operate multiple user devices 108, which is depicted as user device 108n, and each user device 108 may have one or more sensors 126.

In existing systems, infrared (IR) based remote controls are often used to operate various physical devices in an environment. However, since IR light may have to be used in order to ensure that the signal reaches the intended device, and given the wide beam angle of the emitted IR light, the user may have to explicitly indicate which device the user is intending to control. This may be done by enabling the user to physically select between multiple remote controls or using a universal remote control that may be configured to control multiple user devices. As the user's attention may be divided between the control interface that is situated on the remote control and the user device that is to be controlled, such an indirect control mechanism may cause both inconvenience and inefficiency.

Moreover, other systems that attempt to support both direct and rich interaction between the user, the remote control, and the device tend to have a substantial amount of infrastructure. For instance, previous systems that utilize handheld projectors to control user devices are typically reliant on stabilizing and rectifying the projected image to align with the physical environment, which may require either a sensing infrastructure, or an onboard camera system to track the projector and compensate for its movement, and to calibrate the projector and the environment. However, since the systems described herein may not rely on tracking the projector (e.g., control device 104) or stabilizing the projected image, the controlling of the user device 108 via the control device 104 may not require a central infrastructure or may not have to perform calibration of the control device 104.

As shown in FIG. 2, the user 102 may make one or more commands 202 via the control device 104. For example, with the purpose of causing the user device 108 to perform one or more function(s) 210, the user 102 may perform some action (e.g., actuating a button, performing a gesture, moving the control device 104, etc.) with respect to the control device 104. In some embodiments, in response to the command 202, the control device 104 may project a visual interface 204 upon any physical surface, which may include a wall, a screen, a ceiling, etc. The visual interface 204 may be an image that is displayable to the user 102 and may include any type of information, including text, images, animation, videos, and/or a user interface that may be used to control the user device 108. For instance, the projected visual interface 204 may represent a user interface that may be used to cause the user device 108 to perform various function(s) 210. In some embodiments, the visual interface 204 may enable the user to perform any actions associated with the user device 108, such as, for example, powering the user device 108 on or off, adjusting the volume, time, brightness, and/or channel of the user device 108, and/or performing any other operation associated with the user device 108. In response to the visual interface 204 being presented to the user 102, the user 102 may make one or more user inputs 206 that may cause the user device 206 to perform certain function(s) 210.

In other embodiments, in response to a particular command 202 from the user 102, the control device may transmit control information 208 to the user device 108. As stated above, the control information 208 may take the form of visible light and may also be the visual interface 204. Moreover, a sensor 126 that is integrated in, or is otherwise associated with, the user device 108 may receive the control information 208. That is, the control information 208 may be directed to the sensor 126 for receipt by the user device 108. In various embodiments, the control information 208 may represent the command 202 submitted by the user 102 and, in response to the control information 208, the user device may perform one or more function(s) 210 that have been requested by the user 102.

As a non-limiting example, assume that the control device 104 is a remote control device, the user device 108 is a lamp, and the command 202 is a user request to adjust the brightness of the lamp. The user 102 may utilize the remote control to enter the command 202 to adjust the brightness of the lamp. For instance, the user 102 may press one or more buttons, make some type of gesture, or take any other action that indicates that the user 102 desires to adjust the brightness of the lamp. In response, the remote control may transmit control information 208 (e.g., visible light) to the lamp, which may represent the user command 202 to adjust the brightness of the lamp. The sensor 126 associated with the lamp may sense the control information 208 once the control information 208 is transmitted to the lamp. In other embodiments, the control information 208 may be a visual interface 204 (or one or more components of the visual interface 204) that is directed towards the sensor 126 of the lamp. Once the lamp, and the associated sensor 126 in particular, determines that the control information 208 is an instruction to adjust the brightness of the lamp, the brightness of the lamp may then be adjusted (e.g., the function(s) 210) by the lamp. Moreover, it is contemplated that the function(s) 210 may include any other function or operation that the user device may perform or be associated with.

In various embodiments, the image (e.g., visual interface) projected by the control device 104 (e.g., handheld projector, device incorporating one or more projector components, etc.) may serve multiple purposes. For instance, the control device 104 may present and/or project the visual interface 204 to the user 102 and, at the same time, the projected image may also embed information and/or codes that may be detected by the sensor 126 of the user device 108. Moreover, by using visible light (e.g., image) as the channel to transmit instructions from the control device 104 to the user device 108, communication between such devices may take place unidirectionally from the control device 104 to the sensor 126 of the user device 108. Alternatively, information and/or communications may be exchanged back and forth between the control device 104 and the user device 108.

Moreover, in the event that communication is transmitted unidirectionally and directly from the control device 104 to the user device 108, an infrastructure (e.g., a wireless network) and/or prior setup (e.g., knowledge of the geometrical layout of the environment, knowledge of the user devices 108, etc.) may be unnecessary. In addition, instead of tracking or calibrating the control device 104, the system 200 described herein may explicitly use the changing location of the projected image (e.g., the visual interface 204 and/or the control information 208) as the basis for interaction between the control device 104 and the user device 108.

In some embodiments, the sensor 126 associated with the user device 108 may be any type of sensor. For instance, the sensor 126 may be a sensor tag that includes a signal indicator (e.g., a signal indication light-emitting diode (LED)) and/or one or more photo sensors. Moreover, each photo sensor may be connected via a circuit to a microcontroller and/or the processor(s) 122 of the user device 108. The circuit may serve as a low-pass filter that may smooth the projected signal and that may facilitate detection of the signal. In other embodiments, a diffuser, such as an acrylic diffuser, may be attached to the front of the sensor 126 so that the sensor 126 is able to robustly detect the control information 208 and/or projected images (e.g., the visual interface 204) from different angles. The photo sensor(s) and the signal indicator (e.g., LED) may be situated on the exterior of the user device 108 such that they are visible to the user 102. Furthermore, the circuit and the microcontroller may be embedded in the interior of the user device 108. However, any physical configuration of the foregoing components of the user device 108 is contemplated.

As stated above, the control device 104 may transmit and/or project the visual interface 204 and/or the control information 208 to the user device 108. In some embodiments, the control device 104 may transmit codes to the sensor 126 of the user device 108 by adjusting, over time, the brightness and/or intensity of pixels associated with the visual interface 204 and/or the control information 208. The brightness and/or intensity of the pixels may be adjusted independently such that the brightness of some pixels may be adjusted while the brightness of other pixels may remain the same. As a result, multiple arbitrary codes may be transmitted concurrently to the user device 108 using different projection regions or components. However, the sensor 126 may be limited to receiving the codes contained in the projected image and/or component(s) that are transmitted directly over the sensor 126.

In various embodiments, the codes that are transmitted from the control device 104 to the user device 108 may be temporal binary codes, such as command codes and location codes. The command codes may encode an individual command, which may be represented by a discrete region or component within the projected visual interface 204, such as on or off buttons. Alternatively, the location codes may identify the location of tags within the projected visual interface 204. In various embodiments, to encode positions and localize the tags, Gray codes may be utilized. More particularly, each frame of the codes may include black and white stripes, which may subdivide the projection area successively. In some embodiments, the horizontal positions within the frames may be encoded and then the vertical positions may be encoded, or vice versa. The horizontal positions and the vertical positions may then be projected in a sequence in order to uniquely identify pixel locations that are included in the visual interface 204.

In some embodiments, the command codes and/or the location codes may be transmitted on demand in response to a user actuation (e.g., pressing a button, interacting with a touch-sensitive display, performing a gesture, etc.) associated with the control device 104. More particularly, the same code may be transmitted multiple times or repeatedly while the user 102 is performing the user actuation associated with the control device 104. In order to transmit any binary code via a visible light channel, the brightness of the pixels included in the visual interface 204 may be varied over time. In various embodiments, pixels having a relatively low intensity (e.g., brightness) and pixels having relatively higher intensities may be represented by different values. For instance, pixels having low intensities may be represented by 0-bits whereas pixels that have high intensities may be represented by 1-bits. As a result of the values assigned to the pixels, the sensor 126 of the user device 108 may be able to detect the contrast between pixels having high and low intensities. That is, the difference between the values may be sufficiently large so that the sensor 126 may detect such differences.

In addition, mapping relative intensities and/or brightness to pixels included in the visual interface 204 may also help ensure that different interface colors yield consistent intensity readings. Therefore, the brightness value of each pixel may be varied to represent the binary code while also preserving the hue value of each pixel and being able to transmit codes at any point in the projected visual interface 204.

In example embodiments, instead of having an additional channel for synchronization of the codes that are transmitted to the user device 108, such synchronization information may be embedded in the visible light channel that may be used for the data transmission (e.g., transmission of the control information 208). In particular, a single frame of black pixels within the code transmission regions may be projected. Moreover, synchronization regions may be situated at the beginning and at the end of the code in order to surround and potentially delimit the single frame, thus also allowing for variable code lengths. In some embodiments, and as a result, such black image frames may be more easily detectable. Furthermore, a single black frame may be less likely to be confused with other conditions (e.g., if the projected image was moved away or was obfuscated temporarily, this would result in a longer interval of a missing signal), and thus may serve as a more reliable indicator to distinguish between normal projection and the start and/or end of code transmission.

Since users 102 may operate the control device 104 and, thus, may control the user device 108 from different locations, distances and angles between the control device 104 and the sensor 126 of the user device 108 may vary. As a result, the sensor 126 may receive different light intensities for the same projected brightness of the visual interface 204 and/or control information 208, depending upon how the control device 104 and the sensor 126 are located with respect to one another. To help ensure that the sensed light intensity and the intended bit value are properly mapped to each other, a calibration sequence may be included in the code transmission sequence after the synchronization frame but before transmitting the actual code. In various embodiments, the complete transmission sequence (e.g., control information 208) for a single code that is transmitted to the user device 108 may include a header, which may include a synchronization segment and a calibration segment, the actual code, and a tail, which may include an additional synchronization segment.

In various embodiments, rapidly changing the pixel brightness for the purpose of code transmission may result in flickering of the image that is being projected. This flickering may be perceived when the user 102 makes some actuation associated with transmitting control information 208 and/or a command to the user device 108, such as by pressing a button on the control device 104. As a result, the flickering may serve as direct visual feedback to the user 102 that indicates that the operation intended by the user 102 is being performed. In some embodiments, to help ensure that the projected visual interface 204 is still recognizable and/or perceivable by the user 102 during code transmission, the visual interface 204 may be rendered based on hue contrast as opposed to brightness contrast.

As stated above, the sensor 126 of the user device 108 may receive the visual interface 204 (including the components included therein) and/or the control information 208 that is projected by the control device 104. In some embodiments, the way in which the sensor 126 physically detects the visible light signal may vary based at least in part on the control device 104 being utilized and/or the type of light being transmitted by the control device 104. For instance, a laser projector that employs a scan-line based approach may be utilized. In particular, one or more modulated laser sources (e.g, red, green, blue, etc.) may be combined into a single beam that is then reflected off a scanning mirror to construct each image pixel sequentially in a zigzag manner. As a result, the sensor 126 that receives the projected image may receive projected light at the time when the laser beam passes over the sensor 126, and an image frame may be detected as a peak in the sensed light intensity. By maintaining the average intensity over a recent time window, the influence of varying ambient lighting may be limited or removed from the peak detection.

Moreover, the sensor 126 (e.g., sensor tag) incorporated in the user device 108 may be any type of sensor. For instance, based at least in part on the hardware associated with the control device 104 and/or the user device 108, and/or the code transmission method used to transmit the visual interface 204 and/or the control information 208 from the control device 108 to the user device 108, the sensor 126 may include at least a single-sensor tag, a dual-sensor tag, and/or a color-sensor tag. As will be discussed in additional detail below, single-sensor and dual-sensor tags may capture light intensity. More particularly, the single-sensor tag may detect discrete interface components within the visual interface 204 as well as location and/or lateral motion within the projected visual interface 204. In addition, the dual-sensor tag may further enable the detection of two-dimensional rotation and/or the distance between the control device 104 and the sensor 126. As discussed in further detail below, a three-sensor tag may also be utilized with respect to pose reconstruction. In further embodiments, the color-sensor tag may enable further interaction possibilities based at least in part on color of the image that is projected by the control device 104. Any of the above sensor tags may include an LED that may provide visual feedback based on whether the sensor 126 was able to detect the image projected by the user 102.

Regardless of the type of sensor tag being utilized, the systems and processes described herein may use a visible user interface that may be directly projected onto the user device 108 that the user 102 intends to control. In various embodiments, there may be no backwards communication channel from the sensor 126 of the user device 108 to the control device 104, meaning that the projected visual interface 204 may be passive, and may not reflect dynamic information about the user device 108, such as internal states of the user device 108.

Moreover, the image that is projected by the control device 104 may include one or more active regions that may represent interface components, such as buttons and/or sliders. The interactions between the control device 104 and the user device 108 may be based at least in part on the user 102 pointing the control device 104 at the user device 108 and the user 102 performing some user actuation (e.g., pressing a button), which may activate the user device 108 to perform certain operations. For example, the interaction may be imitated by the user 102 aiming the projected visual interface 204 at the user device 108 and overlaying a particular one of the components (e.g., a button, a slider, a switch, etc.) of the visual interface 204 on the sensor 126 (e.g., the sensor tag). In various embodiments, during the user actuation, the active areas within the projected image may transmit their respective codes simultaneously, but the code that is overlaid directly on the sensor tag will be received. Depending upon the action that the user 102 intends to perform with respect to the user device 108, the user 102 performing the user actuation and overlapping the desired component over the sensor tag may cause the action to be performed by the user device 108. Furthermore, the user 102 may also move the control device 104 and the respective projected visual interface 204 while actuating a button on the control device 104, which may allow for gestures to be received by the sensor 126. In some embodiments, the active region may cover the entire image to enable larger scale gesture detection by localizing a tag's position across the entire projection area.

Certain user interface components, such as on-off switches, sliders or knobs for adjusting a single parameter (e.g., volume, channel, etc.), may be made universally applicable to control devices 104 and also could be interpreted appropriately by the respective user device 108. Therefore, some projected visual interfaces 204 may be re-used across multiple user devices 104, and may also have the same layouts and codes. On the contrary, other functionality may be user device-specific, whereby the user device 108 may have to be operated using a dedicated control interface. In these embodiments, user device identification headers may be added to the code transmitted by the control device 104 in order to avoid duplicate codes across different user devices 108. Users 102 may be able to cycle through available sets of projected visual interfaces 204 using buttons or some other mechanism for inputting user instructions on the control device 104. In addition, visual interfaces 204 for a particular user device 108 could be added to the control device 104 by acquiring and/or downloading them from a particular source (e.g., website, etc.). In some embodiments, these visual interfaces 204 may be customizable to allow the users 102 to create interface layouts that suit the users' 102 personal preferences and/or usage patterns.

As mentioned previously, a single-sensor tag may be utilized to receive information transmitted from the control device 104. In particular, the single-sensor tag may utilize a single sensor to capture projected light intensities transmitted by the control device 104. The single sensor 126 may decode the information embedded within the active projection region that is situated directly over the sensor 126 in order to enable certain interactions between the control device 104 and the user device 108. In various embodiments, static interactions (e.g., using command codes) and/or motion-based interactions (e.g., using location codes) may be utilized. Static interactions, such as the user 102 activating a single command, may have users 102 first overlay the corresponding region of the visual interface 204 over the sensor tag, and then possibly perform some user actuation with respect to the control device 104 (e.g., press a button) in order to complete the interaction. In addition, motion-based interaction may integrate moving the projection across the sensor tag, which may also include actuating the button (or other mechanism) on the control device 104. In either scenario, instead of moving a cursor to indicate the location in a static user interface as in conventional GUIs, the sensor tag may represent the cursor and may be fixed while the projected visual interface 204 as a whole is being moved.

In various embodiments, static interaction utilizing a visual interface 204 may be used to operate and/or control a particular user device 108, such as a lamp. For instance, the visual interface 204 may be designed to switch the lamp on/off or adjust the brightness of the lamp via one or more mechanisms (e.g., buttons, a touch-sensitive display, etc.) situated on the control device 104. In the context of a lamp, the sensor 126 may be associated with the lamp (e.g., mounted on the shade or base) and the user 102 may overlay one of a plurality of components included in the visual interface 204 on the sensor 126. Once a particular component is positioned over the sensor 126, the user 102 may activate the component utilizing the control device 104. While different command codes may be transmitted within the various components in the visual interface 104 at the same time, the sensor 126 may be limited to receiving the command from the component that is situated directly over the sensor 126. The user 102 may then receive feedback and/or confirmation that the user command was received by the lamp, which may be indicated by a lighting state of the lamp (e.g., on, off, brighter, dimmer, etc.). Since the user 102 is able to control the lamp via the visual interface 204, and because the visual interface 204 may be projected onto the sensor 126 of the lamp, the user 102 may control the lamp utilizing the control device 104, and without having to divide his/her attention between the projected visual interface 104 and the user device 108 (e.g., lamp).

As opposed to static interaction, motion-based interaction may enable different interactions between the user 102 and the user device 108. For instance, the user 102 may move the location of the visual interface 204, and/or components within the visual interface 204, across the sensor 126 of the user device 108 for the purpose of controlling the user device 108. This may mitigate the difficulty of attempting to point components of the visual interface 204 directly at the sensor 126 and may also mitigate involuntary movement introduced by the user 102 indicating an intent to submit a command to the user device 108, such as by pressing a button on the control device 104. In some embodiments, the user 102 may overlay at least a portion of the visual interface 204 (e.g., a component) on the sensor 126 and then may move the projection (e.g., vertically, horizontally, diagonally, or a combination thereof) over the sensor 126. The command being transmitted to the user device 108 may be transmitted when the user 102 actuates a button or releases the button. In some embodiments, upon a particular portion (e.g., component) of the visual interface 204 crossing the sensor 126, the component that overlays the sensor 126 may cause the user device 108 to perform a specific operation.

In other embodiments, the functionality of the user device 108 may be controlled utilizing visual sliders depicted in the visual interface 204. For instance, using the lamp example set forth above, the brightness of the lamp may be controlled using one or more visual sliders. Moreover, a particular region of the visual slider may be filled with location codes when the user actuation is received and slider positions may be mapped to brightness values associated with the lamp. As a result, the user 102 may either drag the slider to adjust values continuously, or may directly select one position in the visual slider that corresponds to a set value (e.g., a particular brightness level). In contrast, the relative motion of the slider may be mapped to the relative change of brightness to achieve a finer control granularity. In this example, the user 102 may perform a clutching action by releasing a button on the control device 104 and dragging the slider an additional time.

In addition, arbitrary two-dimensional gestures may be performed by the user 102 and then received by the sensor 126 of the user device 108. Such two-dimensional gestures may be performed by projection a location code pattern that spans over the entire projected image. In some embodiments, this pattern may be projected on demand, such as when the user 102 is activating a button or some other mechanism on the control device 104. Moreover, each gesture may be demarcated by a pair of button press-release-actions, which may help avoid random movement to be interested as input. For instance, the user 102 may actuate the button, move the control device 104 in a direction, and then release the button. More particularly, if the user 102 desires to navigate through a gallery of electronic photographs, the user 102 may aim the projected visual interface 204 at the photographs, actuate one of the activation buttons of the control device 104, and flick the control device 104 in a certain direction to scroll to different photographs. For example, the user 102 may flick the control device to the left or right for going backwards or forwards, respectively, through the gallery.

Although static interactions and motion-based interactions have been described separately, static and motion-based visual interface components may be combined in the projected visual interface 204 to create a more complex visual interface 204. For example, the visual interface 204 may contain static buttons (e.g., selecting a channel) and a motion-based slider (e.g., for volume adjustment) in a single projected visual interface 204. In addition, such projected visual interfaces 204 may be customized based at least in part on the user's 102 personal preferences.

As mentioned previously, since the target devices (e.g., user devices 108) may be directly indicated through pointing the visual interface 204 directly at a particular user device 108, the user 102 need not explicitly select an intended user device 108. Moreover, in addition to using the same projected visual interface to control multiple user devices 108 individually, users 102 may also combine interactions with multiple user devices 108 into one. For instance, users 102 may direct the control device 104 (e.g., point, perform a gesture, etc.) over multiple user devices 108 in order to control each of the multiple user devices 108 in a single motion.

The control device 104 may also be utilized to control user devices 108 that are too small to accommodate a user interface of their own (e.g., a music player device). Similarly, the systems and processes described herein may be used for text input on user devices 108 that are too small to have their own keyboard by projecting a visual keyboard over the user device 108. That is, the visual interface 204 that is projected by the control device 104 may be a keyboard that may be utilized to enter text associated with the user device 108. More particularly, the user 102 may input text by moving the projected keyboard to overlay the desired character on the sensor 126 of the user device 108. When the intended character is situated over the sensor 126, the sensor 126 may detect that particular character and/or the user 102 may indicate some user actuation (e.g., press a button) to select that character. Alternatively, the user 102 may also project the visual interface 204 statically, such as by projecting the visual interface 204 on a nearby surface (e.g., wall, table, etc.), and move the user device 108 itself to the desired character. Therefore, the user device 108 may be used as a pointing device for direct interaction with the projected visual interface 204. In addition, the user 102 may situate the user device 108 between the control device 104 and the display surface in which the visual interface 204 is to be projected, thus casting a shadow on the projected character of interest. In any case, when the user 102 actuates a button, the respective character input may be transmitted through the sensor 126 to the user device 108.

In other embodiments, and as stated above, a dual-sensor tag may be utilized whereby two sensors may be associated with, attached to, and/or incorporated in the user device 108. Although two sensors 126 are described below, more than two sensors 126 may also be utilized. For example, a three-sensor tag could be utilized that may be configured to sense full three-dimensional rotation and translation between the control device 104 and the sensors 126. In the dual-sensor tag context, the two sensors 126 may be the same or different and may be affixed or mounted to the user device 108 in the same plane at a certain distance apart from one another. Moreover, the two sensors 126 may be connected to the same, or a different, control circuit. Using location codes as described above, the dual-sensor tag may detect at least two separate locations within the projected image simultaneously, one from each of its sensors 126. As a result, the dual-sensor tag may enable the sensing of additional degrees of freedom, such as rotation and/or distance, and extended gestural interaction.

In various embodiments, the degree of rotation of the control device 104 and/or the projected visual interface 204 around the dual-tag sensor may be determined. In particular, the projected visual interface 204 may be depicted as a grid having an x-axis and a y-axis, which may be referred to as a projection coordinate space. In the above embodiments, two locations in the projection coordinate space (determined using location codes, e.g., Gray codes), in conjunction with the known physical layout of the sensors 126, allow for recovering the two-dimensional rotation angle between the control device 104 and the sensor 126 of the user device 108. For example, the rotation angle (a) may be determined by utilizing Equation 1, as shown below:

α=a tan 2(y₂−y₁,x₂−x₁), (1)

where (x₁, y₁) may refer to the detected location of the first sensor 126 and (x₂, y₂) may refer to the detected location of the second sensor 126. Moreover, a tan 2 may refer to a two-argument function that is a variation of the arctangent function. More particularly, for any real arguments x and y that are both not equal to zero, a tan 2(y, x) may be the angle in radians between the positive x-axis of a plane and the point given by the coordinates (x, y).

As a result, and in view of Equation 1, the maximum angular resolution may be determined by the detected distance of the two sensors 126 in the Gray code coordinate system, which in turn may be dependent upon the physical distance between the two sensors 126 (a larger distance may result in a higher angular resolution), the grid density of the projected Gray code (a more dense grid may result in a higher angular resolution), and/or the projection distance between the control device 104 and the sensor tags (a smaller distance may result in a higher angular resolution). In various embodiments, if both of the two sensors 126 fall within the same grid cell and report the same location, the rotation angle (α) possibly may not be determined. Moreover, while the first two parameters (distance between sensors 126 and grid density) may be fixed values, and may be subject to compromise with other design variables (e.g., tag size and code length), the projection distance can be adjusted by the user 102 so that the user 102 is able to select a point between optimum resolution and convenience based on the present circumstances.

In other embodiments, the distance between the control device 104 and the dual-sensor tag may be inferred and/or determined. More particularly, if the user 102 moves the control device 104 further away from the sensors 126 of the user device 108, the visual interface 204 that is being projected will logically increase, thus causing a larger projection. Therefore, the detected distance between the two sensors 126 with respect to the Gray code coordinates may decrease (and vice versa). This may allow the sensors 126 to detect relative change in projection distance. In addition, if the control device's 104 ThrowRatio (e.g., the ratio between the projection distance and the physical width (W_{Proj}) of the projected image (e.g., visual interface 204)) is known, the absolute physical distance between the control device 104 and the sensors 126 (D_{Proj}) may be determined utilizing Equations 2 and 3, as shown below:

$$\begin{matrix}{D}_{Proj} = ThrowRatio \times {W}_{Proj} , & ( 2 ) \\ where , \\ {W}_{Proj} = \frac{{ResolutionX}_{code} \times {D}_{sensors}}{{D}_{code}} & ( 3 )\end{matrix}$$

In various embodiments, Dₛₑₙₛₒᵣₛ may refer to the physical distance between the two sensors 126, and ResolutionX_{code} may refer to the number of Gray code grid cells along the projection's x-axis, both of which may be fixed. Moreover, D_{code}=\sqrt{(x₁−x₂)²+(y₂−y₂)²} may refer to the detected sensor distance in the Gray code coordinate, which may be used to calculate W_{Proj} (physical projection width) and, in turn, D_{Proj}. In various embodiments, the Gray code grid cells may be square, however, Equations (2) and (3) may be adapted for non-square cells. Further, the maximum detectable projection distance may be reached once both of the two sensors 126 fall within the same Gray code grid cell (e.g., both sensors 126 report the same location).

In further embodiments, the rotation and distance described above may be determined without internal sensors on the control device 104 and/or without an external tracking infrastructure. Moreover, since the relative position and orientation between the control device and the sensor 126 may be directly sensed, interactions therebetween may be relative to the sensor(s) 126, regardless of the sensor's 126 absolute position and/or orientation and also regardless of the control device's 104 absolute position and/or orientation, which may allow the deployment of the sensors 126 to be flexible. For example, the sensors 126 and the corresponding user devices 108 may be freely repositioned by the user 102, and/or the user device 108 may itself move during the interaction. For the most accurate rotation and distance data, the projected image (e.g., visual interface 204) and the sensor 126 plane may have to be approximately parallel to one another. Although projecting the visual interface 204 at an angle may result in less reliable detection results, such moderate inaccuracies may be small and not detrimental since the user 102 may attempt to project a legible visual interface 204.

The following are examples of a user 102 controlling a user device 102 utilizing the dual-sensor tag process described above. In various embodiments, rotation of the control device 104 and, therefore, the projected usual interface 204 may be used to input continuous values. For example, assume that the user device 108 is an analog clock having a dual-sensor tag (e.g., two sensors 126). To set the hour and/or minute of the clock, the user may point either the minute or the hour control component within the visual interface 204 at the clock with the projected hand at the desired angle. When the user 102 actuates a mechanism on the control device 104 (e.g., presses a button), the control device 104 may transmit the location codes within both interface components. Therefore, the rotation between the control device 104 and the clock may be detected and used to directly set the respective clock hand to the indicated angle. Moreover, the user 102 may continue to rotate the projection while actuating the control device 104 mechanism in order to further specify the desired time.

In other embodiments, the dual-tag sensor system may also be used in the context of mobile devices, such as home robots, remote control cars, etc. When controlling such user devices 108, movement of the control device 104 and movement of the user device 108 may be taken into consideration. In various embodiments, the user device 108 (e.g., a remote control toy car) may be controlled utilizing a control device 104 and based at least in part on a dual-sensor tag being affixed to, or otherwise associated with, the user device 108. In the following embodiments, a toy car may be controlled using direct-manipulation and/or follow-the-center techniques.

With the direct-manipulation technique, the user 102 may overlay the projection (e.g., visual interface 204) with the toy car's dual-sensor tag, press an activation button on the control device 104, and then rotate the control device 104 to rotate the toy car at that particular moment. The sensors 126 associated with the toy car may record the initial angle between the toy car and the control device 104 when the location code is first projected, and may subsequently continue to rotate the toy car if the angle is being changed, in order to match the initially-recorded angle. As a result, the toy car may maintain its initial angular alignment with the projection, as if the user 102 is directly rotating the toy car itself.

In addition, swiping the projection along the toy car's main axis while actuating the button on the control device 104 may cause the toy car to begin moving in the direction of the swipe. In some embodiments, the projection itself may be at an arbitrary angle to the toy car, as long as the direction of the swipe roughly aligns with the toy car's main axis (as the sensor tags may compensate for lateral motion in different directions by knowing the absolute angle between itself and the projection). Furthermore, if the toy car is currently moving when the user 102 makes the swiping motion, the toy car may accelerate or decelerate depending on whether the detected swiping direction is the same or is opposite to the current direction that the toy car is currently moving. Since the swiping motion may be sensed relatively between the projection and the toy car, this also may allow a static projection to serve as a barrier to slow down and eventually stop a moving toy car, as from the toy car's perspective, a motion opposite to the current driving direction is detected.

In some embodiments, although the toy car may be interpreting the commands transmitted from the control device 104 relative to itself, the user 102 may have the impression that the user 102 is directly manipulating the toy car as if the user 102 was using their hand to directly manipulate the toy car. Therefore, the control mechanism may remain the same regardless of which direction the user 102 and/or the toy car are facing. This is in contrast to existing systems in which the user 102 operates the car toy from the car toy's perspective, and also performs counterintuitive mental rotation when facing a different direction than the car toy.

With the follow-the-center technique, the toy car may consistently move towards the center of the projected image (e.g., visual interface 204). In these embodiments, the control device 104 may transmit Gray codes continuously without user activation. Moreover, by sensing the rotation and/or location of the sensors 126 with respect to the projection, the toy car may be able to determine the position of the projection center relative to itself and move accordingly. Users 102 may catch the toy car by aiming the projection directly at the toy car, and the toy car may then move to and follow the center of the projection, with the projection acting as a virtual leash. Accordingly, the user 102 may guide the toy car through an arbitrary route, which may then be recorded by the toy car and replayed at a later time.

In addition to the sensors 126 being configured to receive and/or sense varying light intensities, the same or different sensors 126 may also be configured to detect color, such as red-green-blue (RGB) color. In various embodiments, the user device 108 may include one or more photo sensors 126, which each may be equipped with a different narrow band-pass color filter matching the wavelength of the respective color channel (R, G, B) in the control device 104 that projects the image (e.g., visual interface 204). The one or more sensors 126 may be situated on the user device 108 in any configuration, such as being mounted with minimal spacing in a triangular arrangement to sense that same projected area. Additionally, other types of RGB sensors 126 may also be utilized.

The color sensor tag may enable direct codification of locations within the projection based on variations in color in a static image, rather than a temporal command and/or a location code sequence. However, the color sensor tag may potentially be combined with temporal codes, for example, to increase the transmission bandwidth by using Gray codes with an n amount of colors, or by separating code transmission and user interface to different color channels to minimize interference and perceived flicker. For example, certain lamps allow the user 102 to set the emitted light to an arbitrary color in order to create a certain ambient atmosphere. Utilizing the systems and/or processes described herein, the user 102 may use the control device 104 to directly choose the color that is to be emitted by the lamp in a single interaction. In these embodiments, while the user 102 actuates some type of mechanism associated with the control device 104 (e.g., the user 102 presses a button), the control device 104 may project a color spectrum. In order to cause the lamp to emit a specific color, the user 102 may move the projected visual interface 204, thereby aligning the desired color with the lamp's color sensor 126. In some embodiments, while moving the projection, the lamp's color may continuously be updated and, to confirm a specific color selection, the user 102 may release the button.

In further embodiments, multi-user interactions may be utilized to control the user device 108. More particularly, multiple users 102 may each project a visual interface 204 from respective control devices 104 and overlap the different projections onto a single sensor 126 of the user device 108. As a result, the user device 108 may perform a specified function provided that a combination of components included in multiple visual interfaces 204 have been detected and received by the sensor 126. In example embodiments, to access a restricted functionality (e.g., unlocking a door), each authorized user 102 may have to overlap their respective projections for simultaneous activation. This combined action may be visualized to the users 102 by visual blending of the projections. For instance, a first user 102 may project a red button, a second user 102 may project a yellow button, and when the two colors are combined and overlaid on the sensor 126, the resulting orange color may indicate that the required permission level has been achieved. In addition to combining multiple projections to cause a particular user device 108 to perform certain operations, the projections from the multiple control devices 104 may be combined to enable new operations that may be performed by the user device 108.

As stated above, the communications (e.g., visual interface 204, control information 208, etc.) that cause the user device to perform various operations may be unidirectional from the control device 104 to the sensor 126 of the user device 108. In some embodiments, the visual and peer-to-peer nature of the communication may be maintained such that information may also be transmitted from the user device 108 to the control device 104. For example, an onboard camera and/or a light sensor on the control device 104 and the existing LED on the sensor 126 may be utilized for such communication. Using temporal coding, internal visible states of the user device 108 may be transmitted back to the control device 104, thereby causing the user device 108 to be visualized by the control device 104 in real time.

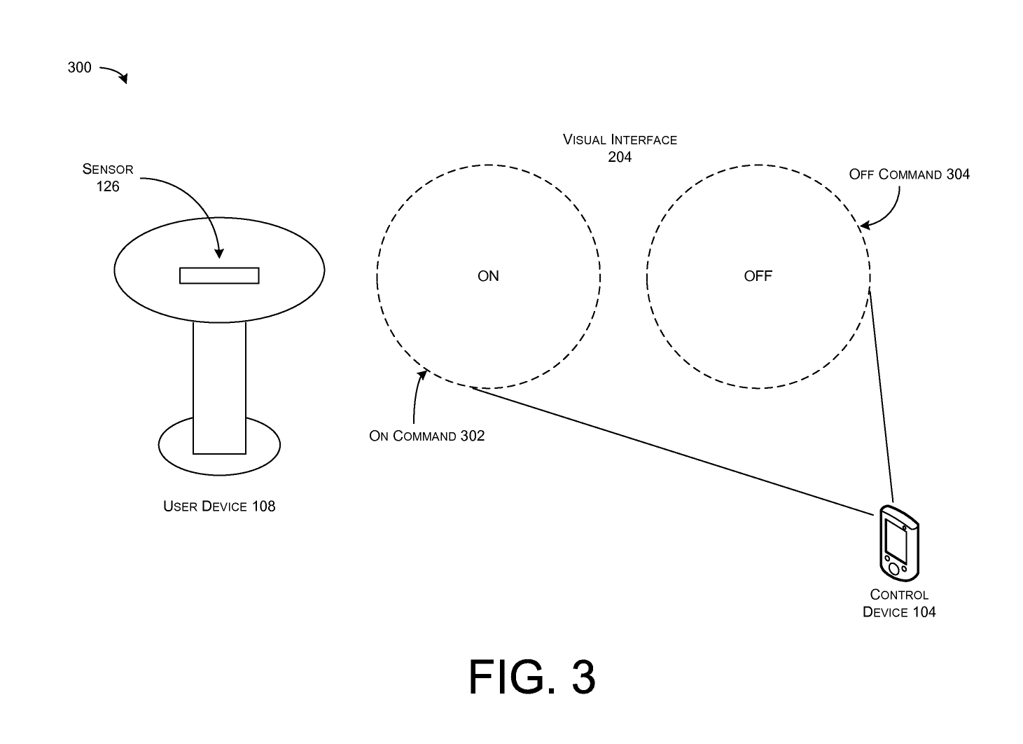

FIG. 3 illustrates an example system 300 for utilizing a control device to operate one or more user devices utilizing visible light. More particularly, a user 102 may utilize a control device 104 (e.g., a remote control) to project a visual interface 204 that may be detected and/or received by a sensor 126 associated with a user device 108. For the purpose of FIG. 3, although the user device 108 may be any type of device (e.g., lamp, television, music player, etc.), assume that the user device 108 is a lamp and that the control device 104 is a remote control device or some other handheld device that is used to control the lamp. Moreover, the user 102 may operate the control device 104 by actuating (e.g., pressing, etc.) one or more mechanisms (e.g., buttons, touch-sensitive displays, etc.) associated with the control device 104.

In some embodiments, when the user 102 desires to cause the lamp to perform a particular function, the user 102 may direct the control device 104 towards the lamp and actuate the mechanism described above. For instance, the user 102 may point the control device 104 at the sensor 126 of the lamp, which may be used to detect visible light transmitted by the control device 104. Upon the user 102 actuating the mechanism on the control device 104, the control device 104 may both transmit a command to the sensor 126 of the user device 108 and may also project an image (e.g., visual interface 204) that may be used to operate the user device 108. The visual interface 204 may be projected on any physical surface, such as a table, a wall, and/or the user device 108 itself. As a result, the user 102 may be able to view different operations that may be performed with respect to the user device 108.

As shown in FIG. 3, although the visual interface 204 may include any number of components that relate to controlling the user device 108, the illustrated visual interface 204 may include two different components—an on command 302 and an off command 304. That is, the user 102 may utilize the projected image to power on and/or power off the user device 108 (e.g., lamp). More particularly, the user 102 may position one of the components and/or commands included in the visual interface 204 over the sensor 126 in order to cause the user device 108 to perform operations associated with that particular command. For instance, if the user device 108 is currently powered off, the user 102 may utilize the control device 104 to project the visual interface 204 and overlay the visual interface 204 on the sensor 126. In particular, the user 102 may overlay the on command 302 on the sensor 126, which may cause the user device to power on, or the user may power on the user device 108 by pressing a button while the on-command is positioned over the sensor 126.

As a result, the sensor 126 may receive instructions from the control device 104 in the form of visible light and the user 102 may also view a user interface that may be used to control the user device 108. Moreover, it is contemplated that the systems and/or processes described above with respect to FIG. 2 may also apply to the example set forth in FIG. 3.

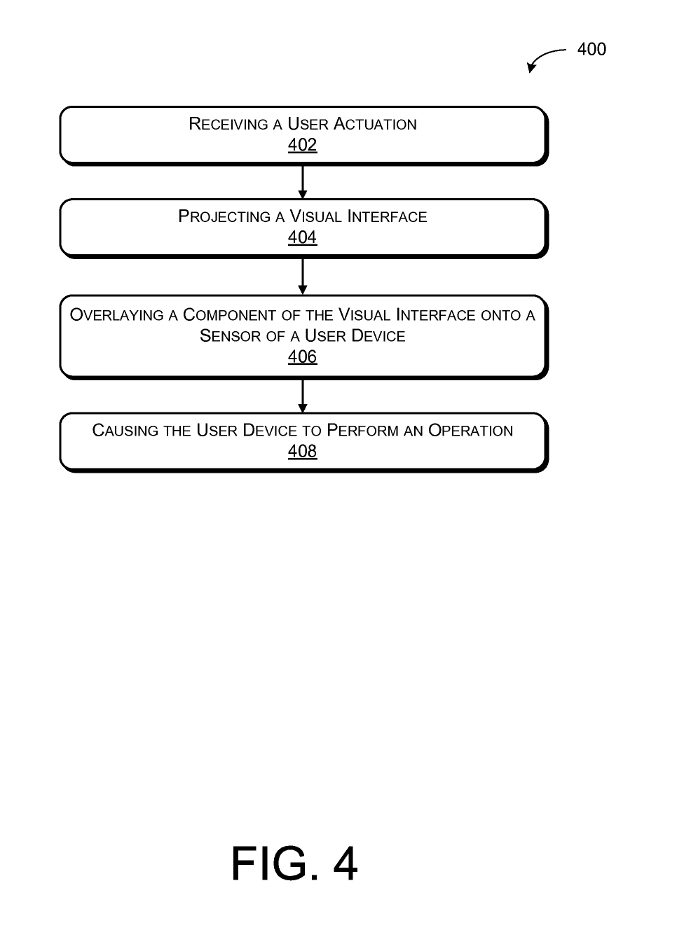

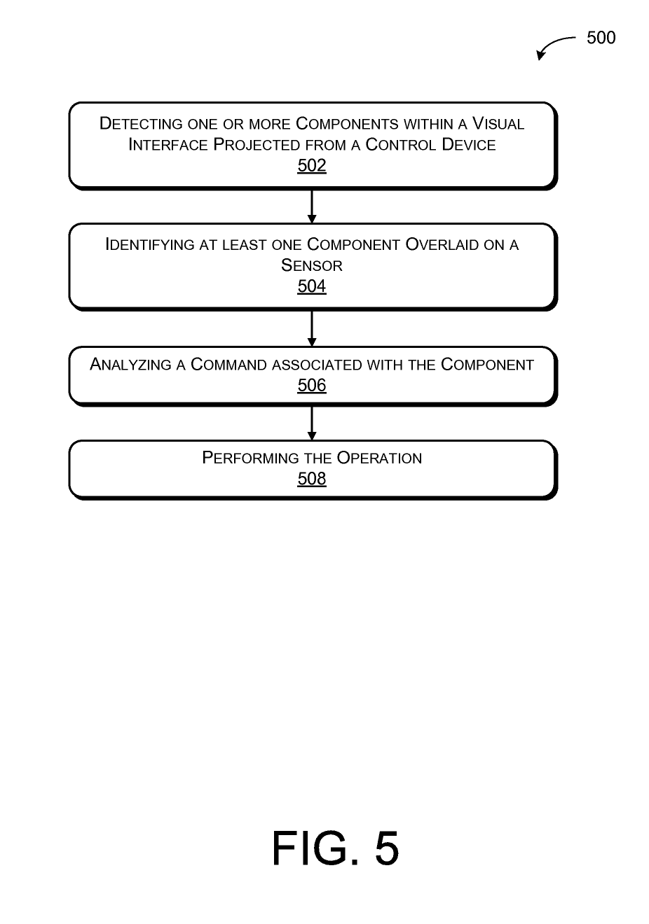

FIGS. 4 and 5 illustrate various example processes for controlling a user device utilizing a control device that may project a visual user interface. The example processes are described in the context of the systems of FIGS. 1-3, but are not limited to those environments. The order in which the operations are described in each example process is not intended to be construed as a limitation, and any number of the described blocks can be combined in any order and/or in parallel to implement each process. Moreover, the blocks in FIGS. 4 and 5 may be operations that can be implemented in hardware, software, and a combination thereof. In the context of software, the blocks represent computer-executable instructions that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 4 is a flowchart illustrating a process 400 for projecting a visual interface that may be utilized to control a user device. In various embodiments, the operations illustrated in FIG. 4 may be performed by the control device 104, as shown in FIGS. 1-3, a remote control, a projector device and/or any other mobile handheld device that may be configured to project an image.

In particular, block 402 illustrates receiving a user actuation. In various embodiments, a user (e.g., user 102) may use any type of mechanism in order to cause a control device (e.g., control device 104) to perform some action. For example, the user may press a button or perform a gesture associated with the control device, and/or interact with a touch-sensitive display that is situated on, or otherwise associated with, the control device. It is contemplated that any type of user actuation may be performed by the user.

Block 404 illustrates projecting a visual interface. More particularly, in response to the user actuation, the control device may transmit control information and/or project a visual interface. In some embodiments, the control information that is projected by the control device may be a visual interface. The visual interface may be a graphical user interface that may depict components, operations, and/or commands that may relate to functionality that may be performed by one or more user devices. For instance, provided that the user device is a lamp, the visual interface may illustrate components that relate to powering the lamp on or off, adjusting the brightness of the lamp, and so on. Moreover, the visual interface may be projected onto any display surface, such as, for example, a wall, a ceiling, and/or a particular user device. As a result, the user may view the visual interface in order to determine which operations may be performed with respect to different user devices.

In other embodiments, the visual interface may be permanently projected, or at least projected prior to receiving the user actuation. As a result, the user may be allowed the opportunity to continuously determine which actions can be taken with respect to the user device. In these embodiments, once a user actuation is received, control information and/or components may be added and/or introduced to the visual interface.

Block 406 illustrates overlaying a component of the visual interface onto a sensor of the user device. More particularly, the user may cause the control device to transmit the control information directly to and/or over a sensor that is incorporated in, or is otherwise associated with, the user device. In addition, the user may manipulate the control device such that a particular component included within the visual interface is directed over, or is overlaid on, the sensor of the user device. Using the example set forth above, if the lamp was turned off, the user may power on the lamp by overlaying a component on the sensor that will instruct the lamp to power on. In some embodiments, the user device may be limited to receiving commands associated with components within the visual interface that are overlaid directly on the sensor. Furthermore, the user may use any mechanism to direct a component of the visual interface over the sensor, such as pressing a button, making a gesture, etc.

Block 408 illustrates causing the user device to perform an operation. In some embodiments, provided that a particular one of the components of the visual interface is projected onto the sensor, a command associated with that component may be detected by the sensor and, therefore, received by the user device. As a result, the user device may perform the operation associated with that component. For example, the lamp described above may power on if the component associated with this function is situated over the sensor.

FIG. 5 is a flowchart illustrating a process 500 for performing a particular operation based at least in part on a visual interface projected by a control device. In various embodiments, the operations illustrated in FIG. 5 may be performed by the user device 108, as shown in FIGS. 1-3, or any other types of device that may be controlled by a user.

Block 502 illustrates detecting one or more components within a visual interface projected from a control device. In some embodiments, one or more sensors may detect when control information and/or a visual interface is being directed at the user device. The visual interface may be projected from a control device and may be an image and/or a graphical user interface that may be projected on any surface, including the user device.

Block 504 illustrates identifying at least one component overlaid on a sensor. As stated above, the visual interface may include one or more components that correspond to operations that the user device may perform. The user device may identify at least one of the components when a particular component is situated over the one or more sensors. In some embodiments, the one or more sensors may detect or identify this component when the component is overlaid on the one or more sensors and possibly when the user performs some type of user actuation with respect to the control device.

Block 506 illustrates analyzing a command associated with the component. In particular, once at least one of the components has been identified, the user device may analyze the component to determine a command, functions, and/or operations that relate to that component. That is, the user device may assume that the component was situated over the sensor(s) because the user desired to control the user device in some manner. As a result, the user device may determine the command that was requested by the user.

Block 508 illustrates performing the operation. In some embodiments, once the command has been identified, the user device may perform the operation and/or function associated with that command. As a result, the user may be able to control and/or operate the user device utilizing a visual interface projected from a control device.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method comprising:
under control of one or more processors of a handheld device:
projecting a visual interface that includes one or more components that each represent one or more operations associated with a user device;
overlaying a particular one of the one or more components of the visual interface on a sensor associated with the user device, the particular one of the one or more components being overlaid on the sensor based at least in part on a user-initiated command with respect to the handheld device; and
causing the user device to perform an operation responsive to the user-initiated command when it is determined that the particular component is detected by the sensor.

2. The method as recited in claim 1, wherein the visual interface is projected in response to a user actuation associated with the handheld device.

3. The method as recited in claim 1, wherein the overlaying includes transmitting visible light or non-visible light to the sensor of the user device.

4. The method as recited in claim 1, wherein the handheld device is at least one of:
a projector device; or
a mobile device that incorporates one or more projector components.

5. The method as recited in claim 1, wherein the projecting presents a graphical user interface to a user through one or more images generated by the handheld device, the one or more images transmitting control information to the sensor by embedding sequential codes through visible light.

6. The method as recited in claim 5, wherein the sequential codes are transmitted to the sensor by changing the brightness of pixels associated with the visual interface.

7. The method as recited in claim 1, wherein the causing includes receiving a user-indication to perform the operation, the user indication including user-actuation of a button, a gesture, or interaction with a touch-sensitive display.

8. The method as recited in claim 1, wherein the operation includes changing a state of the user device, adjusting a continuous value associated with the user device, accessing functions of the user device that are not represented by the one or more components, or controlling a motion of the user device.

9. One or more computer-readable media having computer-executable instructions that, when executed by one or more processors, configure the one or more processors to perform operations comprising:
detecting one or more components included within a visual interface that is projected by a control device;
identifying a particular one of the one or more components when the particular component is overlaid on a sensor, the particular component representing an operation to be performed; and
analyzing the particular component to determine an operation that corresponds to the particular component and performing the operation.

10. The computer-readable media as recited in claim 9, wherein the detecting and the identifying are performed by one or more sensors that are integrated in or are associated with a user device.

11. The computer-readable media as recited in claim 9, wherein each of the one or more components represent an operation that can be performed by a user device.

12. The computer-readable media as recited in claim 9, wherein the operations further comprise analyzing control information to identify specific areas within the projected visual interface.

13. One or more computer-readable media having computer-executable instructions that, when executed by one or more processors, configure the one or more processors to perform operations comprising:
in response to a user actuation, projecting control information using visible light;
directing a particular portion of the control information to a sensor of a user device, the particular portion of the control information representing an operation to be performed by the user device of a plurality of operations contained in the control information; and
causing the user device to perform the operation when it is determined that the sensor has detected the particular portion of the control information.

14. The one or more computer-readable media as recited in claim 13, wherein the projecting control information includes projecting a visual interface upon a viewing surface.

15. The one or more computer-readable media as recited in claim 13, wherein the operation is performed based at least in part on a second user actuation or a continuation of the user actuation.

16. The one or more computer-readable media as recited in claim 13, wherein the control information is a visual interface that includes at least one component that, when overlaid on the sensor, causes the user device to perform the operation.

17. The one or more computer-readable media as recited in claim 13, wherein the control information includes one or more codes that are located in different regions of the control information, the one or more codes being transmitted by changing a color of pixels over the time, the color of the pixels relating to a brightness, a saturation, or a hue associated with the pixels.

18. The one or more computer-readable media as recited in claim 13, wherein the operations further comprise determining a distance between the handheld device and the user device.

19. The one or more computer-readable media as recited in claim 13, wherein the operations further comprise determining a rotation of the handheld device with respect to the user device.

20. The one or more computer-readable media as recited in claim 13, wherein the sensor is a single-sensor tag, a dual-sensor tag, a three-sensor tag, or a color-sensor tag.
